(19) United States
(12) Patent Application Publication
(10) Pub. No.: US 2012/0121248 A1
(43) Pub. Date: May 17, 2012

(54) PHOTOGRAPHING DEVICE AND LENS DEVICE

(75) Inventor: Masahiro SHIRONO, Yokohama-shi (KR)

(73) Assignee: Samsung Electronics Co., Ltd., Gyeonggi-do (KR)

(21) Appl. No.: 13/297,918

(22) Filed: Nov. 16, 2011

(30) Foreign Application Priority Data
Nov. 16, 2010 (JP) 2010-256119

(51) Int. Cl. G03B 11/00; G02B 27/12; G02B 7/02

(52) U.S. Cl. 396/544; 359/811; 359/619; 359/819

(57) ABSTRACT

A photographing device is provided, in which an exchangeable lens unit including an image-forming optical system for capturing an image of an object on a photographing element, an end lens interposed between the image-forming optical system and the photographing element, an end lens support for supporting the end lens, and a first mounting unit, and a main body including a second mounting unit to which the first mounting unit is mounted, the photographing element disposed inside the second mounting unit, and an opening unit installed at a side of the photographing element in the second mounting unit, for receiving the end lens therein.

### PRIORITY

This application claims priority under 35 U.S.C. §119(a) to a Japanese Patent Application filed in the Japan Patent Office on Nov. 16, 2010 and assigned Serial No. JP2010-256119, the content of which is incorporated herein by reference.

### BACKGROUND OF THE INVENTION

1. Field of the Invention

The present invention relates generally to a photographing device and a lens device thereof

2. Description of the Related Art

Japanese Patent Laid-Open Publication No. 2009-017079 provides a method for installing a second photographing element for general high-definition photography behind a first photographing element for integral photography and, when a general high-definition capturing mode is selected, passing photographing luminous flux through the first photographing element.

In addition, Japanese Patent Laid-Open Publication No. 2007-004471 provides a method for achieving a focal image at any distance from one shot by receiving luminous flux from areas of an image-forming optical system, having different exit pupils, at different pixels of a photographing element using a fly's eye lens array and combining the resulting images.

However, the fly's eye lens array is of a same or similar size as the photographing element, and is located in the vicinity of the photographing element. Therefore, in a lens-exchangeable system, if a fly's eye lens array is installed at an exchangeable lens, the fly's eye lens array interferes with a component of a main body of the lens-exchangeable system during mounting or removing the exchangeable lens.

### SUMMARY OF THE INVENTION

Accordingly, the present invention is designed to address at least the problems and/or disadvantages described above and to provide at least the advantages described below.

Accordingly, an aspect of the present invention is to provide a novel improved photographing device and lens device for suppressing interference between an end lens and a component of a main body, and enabling system miniaturization, in a system having an exchangeable lens with an end lens, such as a fly's eye lens array.

In accordance with an aspect of the present invention, a photographing device is provided in which an exchangeable lens unit including an image-forming optical system for capturing an image of an object on a photographing element, an end lens interposed between the image-forming optical system and the photographing element, an end lens support for supporting the end lens, and a first mounting unit, and a main body including a second mounting unit to which the first mounting unit is mounted, the photographing element disposed inside the second mounting unit, and an opening unit installed at a side of the photographing element in the second mounting unit, for receiving the end lens therein.

In accordance with another aspect of the present invention, a lens device is provided in which an image-forming optical system for capturing an image of an object on a photographing element installed in a main body of a photographing device, an end lens interposed between the image-forming optical system and the photographing element, an end lens support for supporting the end lens, and a lens mounting unit mounted to the main body.

In accordance with another aspect of the present invention, a photographing device is provided in which an exchangeable lens unit including an image-forming optical system for capturing an image of an object on a photographing element, an end lens interposed between the image-forming optical system and the photographing element, an end lens support for supporting the end lens, and a first mounting unit, and a main body including a second mounting unit to which the first mounting unit is mounted, the photographing element disposed inside the second mounting unit, and an opening unit installed at a side of the photographing element in the second mounting unit, for receiving the end lens therein. The first mounting unit is mounted to the main body by rotating with respect to the main body.

In accordance with another embodiment of the present invention, a lens device is provided in which an image-forming optical system for capturing an image of an object on a photographing element installed in a main body of a photographing device, an end lens interposed between the photographing optical system and the photographing element, an end lens support for supporting the end lens, and a lens mounting unit detachably mounted to the main body. The first mounting unit is mounted to the main body by rotating with respect to the main body.

In accordance with another embodiment of the present invention, a photographing device is provided in which an exchangeable lens unit including an image-forming optical system for capturing an image of an object on a photographing element, an end lens interposed between the image-forming optical system and the photographing element, a fly's eye lens array support for supporting the end lens, and a first mounting unit, and a main body including a second mounting unit that mounts to the first mounting unit by rotating the first mounting unit with respect to the main body, the photographing element disposed inside the second mount, and an opening unit installed at a side of the photographing element in the second mounting unit, for receiving the end lens therein.

In accordance with a further embodiment of the present invention, a photographing device is provided in which an exchangeable lens unit includes an exchangeable lens unit including an image-forming optical system for capturing an image of an object on a photographing element, an end lens interposed between the image-forming optical system and the photographing element, an end lens support for supporting the end lens, and a first mounting unit, and a main body including a second mounting unit to which the first mounting unit is mounted, the photographing element disposed inside the second mount, and an opening unit installed at a side of the photographing element in the second mounting unit along a trajectory that the end lens draws when the exchangeable lens unit is rotated to be mounted to the main body, for receiving the end lens therein.

### BRIEF DESCRIPTION OF THE DRAWINGS

The above and other aspects, features, and advantages of certain embodiments of the present invention will be more apparent from the following detailed description taken in conjunction with the accompanying drawings, in which:

FIG. 1 illustrates a photographing device according to an embodiment of the present invention;

FIG. 2 is a perspective view illustrating a mounting unit of a main body according to an embodiment of the present invention;

FIG. 3 is a perspective view illustrating a mounting unit of an exchangeable lens, as seen from a main body, according to an embodiment of the present invention;

FIG. 4 illustrates a positional relationship between a fly's eye lens array, a fly's eye lens array support tube, and a rectangular opening unit installed in a main body, according to an embodiment of the present invention;

FIG. 5 illustrates positional relationship between a fly's eye lens array, a fly's eye lens array support tube, and a rectangular opening unit installed in a main body according to an embodiment of the present invention;

FIGS. 6A and 6B illustrate an adapter including a fly's eye lens array built in it, according to an embodiment of the present invention;

FIG. 7 illustrates a photographing device according to an embodiment of the present invention;

FIG. 8 illustrates a photographing device according to an embodiment of the present invention; and

FIGS. 9A and 9B illustrate a photographing device according to an embodiment of the present invention.

Throughout the drawings, the same drawing reference numerals will be understood to refer to the same elements, features and structures.

### DETAILED DESCRIPTION OF EMBODIMENTS OF THE INVENTION

Various embodiments of the present invention will now be described in detail with reference to the accompanying drawings. In the following description, specific details such as detailed configuration and components are merely provided to assist the overall understanding of these embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness.

While a fly's eye or compound eye lens array is used as an end lens interposed between an image-forming optical system and a photographing element, i.e., an image sensor, in embodiments of the present invention described below, this is purely exemplary. Thus, it is to be understood that the embodiments of the present invention are applicable to other end lenses, which are inserted into a main body of a photographing device.

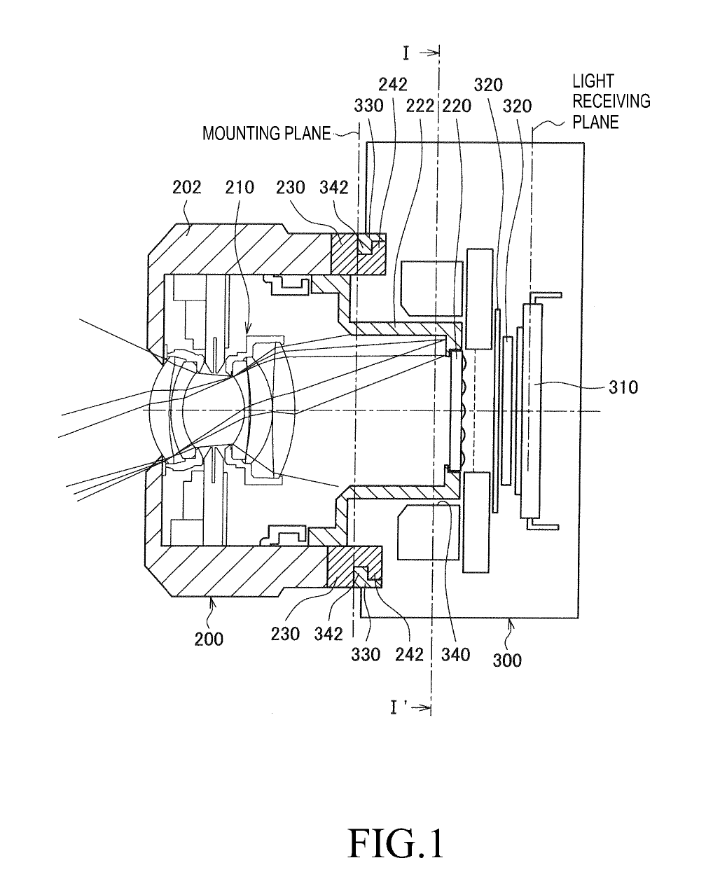

FIG. 1 illustrates a photographing device according to an embodiment of the present invention.

Referring to FIG. 1, the photographing device includes an exchangeable lens 200, i.e., an exchangeable lens unit, and a main body 300. An image-forming optical system 210 is installed in the exchangeable lens 200 to form an image of an object on a photographing plane of a photographing element 310. A fly's eye lens array 220 is disposed at the rearmost of the image-forming optical system 210 (nearest to the main body 300). The fly's eye lens array 220 is supported by a fly's eye lens array support tube 222, i.e., a tube-shaped fly's eye lens support, mounted to a lens body 202 of the exchangeable lens 200. For example, the fly's eye lens array 220 enables formation of a focal image at any distance from one shot by receiving luminous flux at each pixel or each set of pixels of the photographing element 310 from an area having a different exit pupil in an image-forming optical system and combining the resulting images. The fly's eye lens array 220 includes a plurality of lens units, and each of the lens units has a convex surface.

As illustrated in FIG. 1, the photographing element 310 is disposed inside the main body 300. A light receiving plane corresponds to the photographing plane of the photographing element 310, in terms of position. In addition, a plurality of optical devices 320 such as a Low Pass Filter (LPF) are positioned in front of the photographing element 310.

The exchangeable lens 200 is provided with a first mounting unit 230 and the main body 300 is provided with a second mounting unit 330. The mounting surfaces of the first and second mounting units 230 and 330 contact at the position of a mounting plane illustrated in FIG. 1. As illustrated in FIG. 1, the exchangeable lens 200 is combined with the main body 300.

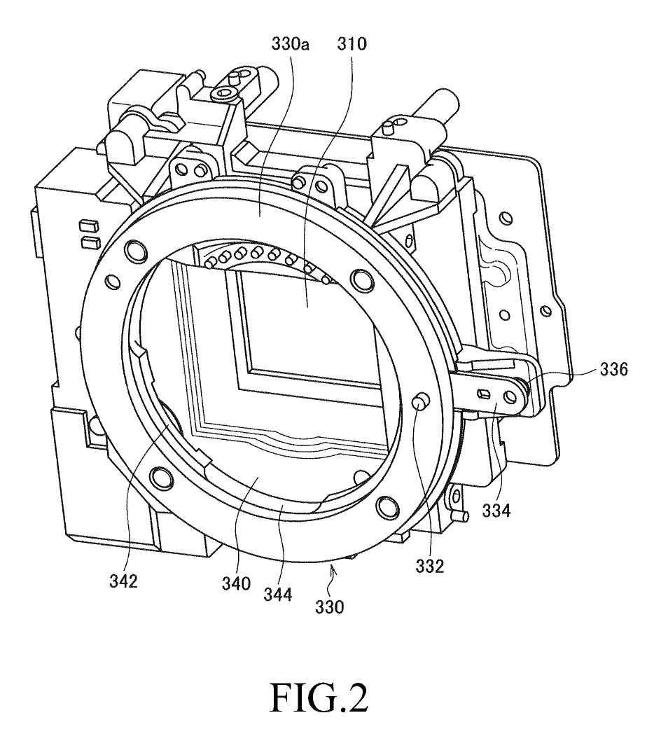

FIG. 2 is a perspective view illustrating the second mounting unit 330 of the main body 300 according to an embodiment of the present invention.

Referring to FIG. 2, the second mounting unit 330 is mounted on a frontal surface of the main body 300. The photographing element 310 is disposed inward from the second mounting unit 330. The optical devices 320 are not illustrated in FIG. 2.

As illustrated in FIGS. 1 and 2, the photographing element 310 is positioned more inward than a second mounting surface 330a in the main body 300.

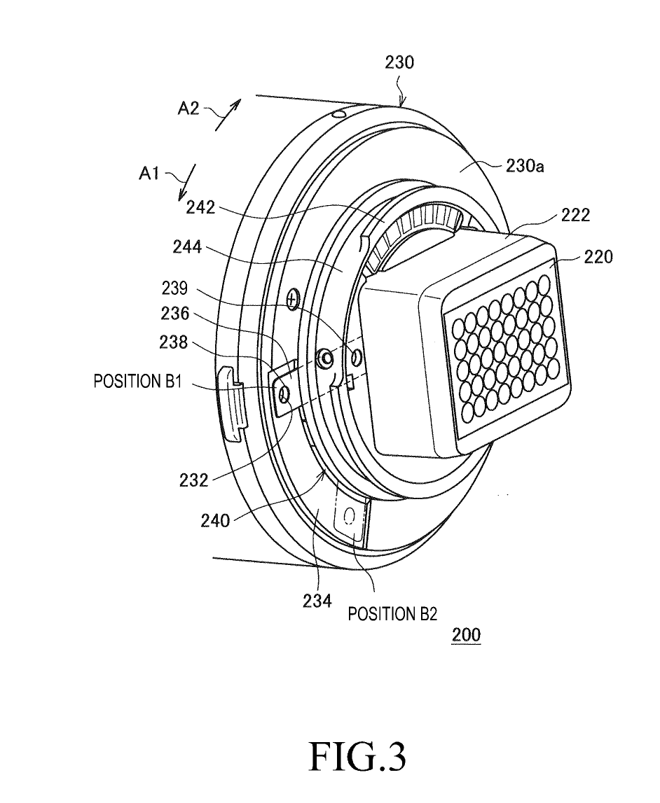

FIG. 3 is a perspective view illustrating the first mounting unit 230 of the exchangeable lens 200, as seen from the main body 300, according to an embodiment of the present invention.

Referring to FIG. 3, at a side of the exchangeable lens 200 to the main body 300, the fly's eye lens array 220 is installed more protruding than a first mounting surface 230a toward the main body 300. The fly's eye lens array 220 is shaped as a rectangle corresponding to a planar shape of the photographing element 310.

As illustrated in FIG. 3, the fly's eye array 220 and the fly's eye lens array support tube 222 are installed more protruding than the first mounting surface 230a toward the main body 330, at the side of the exchangeable lens 200 that is closer to the main body 300. Therefore, an opening unit 340 penetrating toward the photographing element 310 is installed inside the second mounting unit 330 of the main body 300, as illustrated in FIG. 2. When viewed from the front of the opening unit 340, the opening unit 340 is rectangular in correspondence with the planar shape of the fly's eye lens array 220 and fly's eye lens support tube 222.

As will be described in more detail below, the first mounting surface 230a of the first mounting unit 230 in the exchangeable lens 200 is brought into contact with the second mounting surface 330a of the second mounting unit 330 in the main body 300 by inserting second protrusions 342 into first unlocking portions 244 while inserting first protrusions 242 into second unlocking portions 344. In this state, the first protrusion portions 242 are engaged with the second protrusion portions 342 by rotating the exchangeable lens 200 to a predetermined angle. As a result, the first mounting unit 230 is engaged with the second mounting unit 330, and thus, the exchangeable lens 200 is combined with the main body 300.

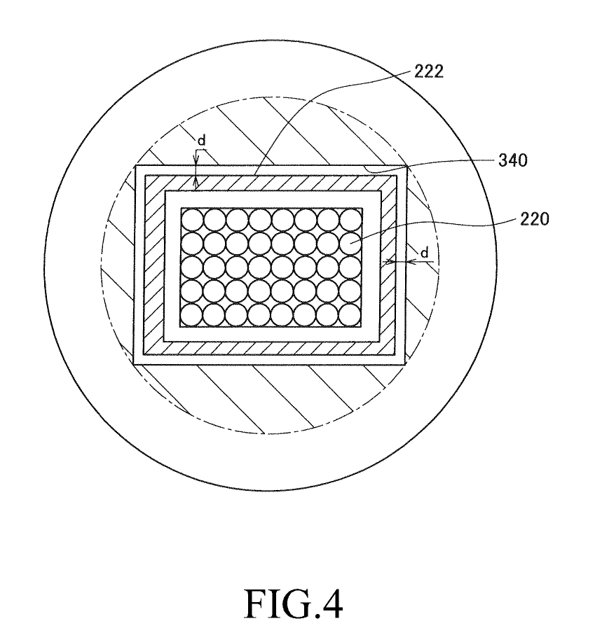

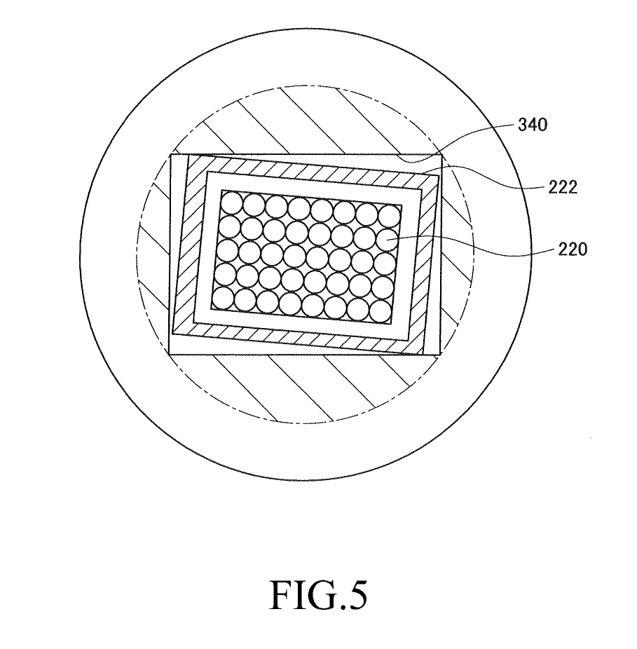

FIGS. 4 and 5 illustrate a positional relationship between the fly's eye lens array 220 and the fly's eye lens support tube 222 and the rectangular opening unit 340 installed in the main body 300, illustrating the section taken along a one-dotted dashed line I-I′ illustrated in FIG. 1.

Referring to FIG. 4, there is a predetermined clearance d between the exterior of the fly's eye lens support tube 222 and the opening unit 340. When the exchangeable lens 200 is formed integrally with the fly's eye lens support tube 222, and the exchangeable lens 200 is rotated with respect to the main body 300 to be mounted or removed, the fly's eye lens support tube 222 interferes with the opening unit 340, as illustrated in FIG. 5.

To avoid the interference illustrated in FIG. 5, the opening unit 340 is formed into a cylinder, and the diameter of the opening unit 340 is increased to be larger than the diagonal length of the fly's eye lens support tube 222, as indicated by a one-dotted dashed line in FIG. 4. As this structure increases the size of the opening unit 340 in the main body 300, it can be expected that valid space is reduced inside the main body 300.

Therefore, in accordance with an embodiment of the present invention, the fly's eye lens array support tube 222 is rotatable with the body of the exchangeable lens 200. According to this structure, the exchangeable lens 200 can be rotated with respect to the main body 300, while the state illustrated in FIG. 4 is maintained. Consequently, the size of the opening unit 340 can be minimized and the opening unit 340 can be shaped into a rectangle of almost the same size as that of the fly's eye lens support tube 222. Accordingly, when a system is built in which the exchangeable lens 200 with the fly's eye lens array 220 can be mounted to or removed from the main body 300, the size of the main body 300 can be minimized.

Referring again to FIG. 2, a locking pin 332 is disposed on the second mounting surface 330a of the second mounting unit 330 in the main body 300. A locking pin unlocking lever 334 and a locking pin spring 336 are positioned in the vicinity of the locking pin 332. When a user presses down the locking pin unlocking lever 334, the top end of the locking pin 332 is lowered in height. When the user removes pressure from the locking pin unlocking lever 334, the locking pin 332 returns to its original position by the restoration force of the locking pin spring 336.

As illustrated in FIG. 2, the second protrusions 342 are formed in the second mounting unit 330, protruding toward a center of the second mounting unit 330. The second protrusions 342 are formed, for example, at three positions within a predetermined angle range on an inner circumference of the second mounting unit 330. A second unlocking portion 344 is interposed between adjacent second protrusions 342. The first protrusions 242 of the first mounting unit 230 in the exchangeable lens 200 are inserted into the second unlocking portions 344.

Referring again to FIG. 3, a first hole 232 is formed into the first mounting unit 230 of the exchangeable lens 200. When the exchangeable lens 200 is combined with the main body 300, a position of the first hole 232 corresponds to the position of the locking pin 332.

A recessed bottom surface 234 is formed within a predetermined angle range, one step lower than the first mounting surface 230a in the first mounting unit 230. A rotation restriction plate 236 of the fly's eye lens support tube 222 is installed rotatably on the recessed bottom surface 234.

The first protrusions 242 protruding outwardly are installed in the first mounting unit 230. The first protrusions 242 are formed, for example, at three positions within a predetermined range on a circumference of the first mounting unit 230. A first unlocking portion 244 is interposed between adjacent first protrusions 242. When the exchangeable lens 200 is mounted to the main body 300, the first protrusions 242 are engaged with the second protrusions 342, thereby combining the exchangeable lens 200 with the main body 300, as illustrated in FIG. 1.

As described above, the fly's eye lens array support tube 222 is rotatable with respect to the body of the exchangeable lens 200. The rotation restriction plate 236 is fixed to the fly's eye lens array support tube 222, for example, using a screw 239, rotatably together with the fly's eye lens array support tube 222. Thus, the rotation restriction plate 236 is inserted into a groove 240 formed in correspondence with its rotation range. When the fly's eye lens array support tube 222 is rotated with respect to the first mounting unit 230, the rotation restriction plate 236 is rotated together with the fly's eye lens array support tube 222, moving within the groove 240.

A second hole 238 is formed into the rotation restriction plate 236. With the exchangeable lens 200 mounted to the main body 300, the rotation restriction plate 236 is located at position B1, as illustrated in FIG. 3, and thus, the position of the first hole 232 corresponds to the position of the second hole 238. When the exchangeable lens 200 is mounted to the main body 300, the locking pin 332 is inserted into both the first and second holes 232 and 238.

When the exchangeable lens 200 is mounted to the main body 300, the locking pin 232 is inserted into the first hole 232 of the first mounting unit 230, thereby locking the exchangeable lens 200 non-rotatably to the main body 300. In this state, as the first protrusions 242 are engaged with the second protrusions 342, the exchangeable lens 200 is locked to the main body 300.

When the user presses down the locking pin unlocking lever 334 to remove the exchangeable lens 200, the locking pin 332 is released from the first hole 232 so that the exchangeable lens 200 is rotatable with respect to the main body 300. Herein, the locking pin 332 is kept inserted into the second hole 238 of the rotation restriction plate 236. Therefore, even though the exchangeable lens 200 is rotated in arrowed direction A2, as illustrated in FIG. 3, the rotation restriction plate 236 is not rotated and as a result, the fly's eye lens array support tube 222 is not rotated either.

When the first mounting unit 230 is rotated integrally with the exchangeable lens 200 to a predetermined angle in the arrowed direction A2, the first protrusions 242 are released from the second protrusions 342, thereby making the exchangeable lens 200 removable from the main body 300. In this state, the position relationship between the rotation restriction plate 236 and the first mounting unit 230 is that the rotation restriction plate 236 is located at position B2, as illustrated in FIG. 3.

To mount the exchangeable lens 200 to the main body 300, the exchangeable lens 236 is inserted into the main body 300 when the rotation restriction plate 236 is located at position B2. The locking pin 332 is then inserted into the second hole 238 of the rotation restriction plate 236. In addition, as the first protrusions 242 are inserted into the second unlocking portions 344 and the second protrusions 342 are inserted into the first unlocking portions 244, the first and second mounting surfaces 230a and 330a are brought into contact. In this state, when the exchangeable lens 200 is rotated in an arrowed direction Al, the locking pin 332 is inserted into the second hole 238. As a result, the position relationship between the locking pin 332 and the fly's eye lens support tube 222 cannot be changed. Accordingly, the fly's eye lens support tube 222 is not rotated with respect to the main body 300, thereby preventing the occurrence of the interference, as illustrated in FIG. 5.

When the locking pin 332 reaches the first hole 232, the locking pin 332 is inserted into the first hole 232, thereby stopping the rotation of the exchangeable lens 200. In this state, as the first protrusions 242 are engaged with the second protrusions 342, the exchangeable lens 200 is combined with the main body 300.

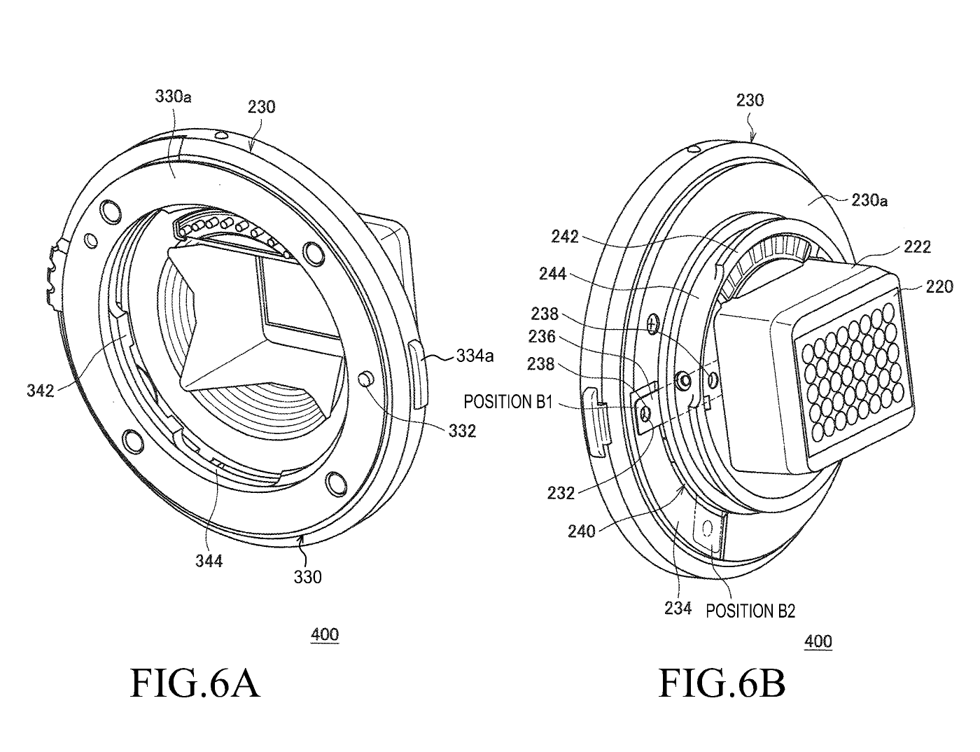

FIGS. 6A and 6B illustrates an adapter 400 having the fly's eye lens array 220 built in it.

Referring to FIGS. 6A and 6B, the adapter 400 includes the first mounting unit 230 having a same structure as the first mounting unit 230 illustrated in FIG. 3 and the second mounting unit 330 having a same structure as the second mounting unit 330 illustrated in FIG. 2, opposite to the first mounting unit 230. However, in FIGS. 6A and 6B, the locking pin unlocking lever 334 illustrated in FIG. 2 is replaced with a locking pin unlocking button 334a. The distance between the first and second mounting surfaces 230a and 330a is limited to a minimum value.

According to the structure illustrated in FIGS. 6A and 6B, the second mounting unit 330 may be mounted to a mounting unit of an exchangeable lens without a fly's eye lens array and the first mounting unit 230 may be mounted to a mounting unit of a main body. Therefore, an exchangeable lens without the fly's eye lens array 220 can function in the same manner as an exchangeable lens with the fly's eye lens array 220.

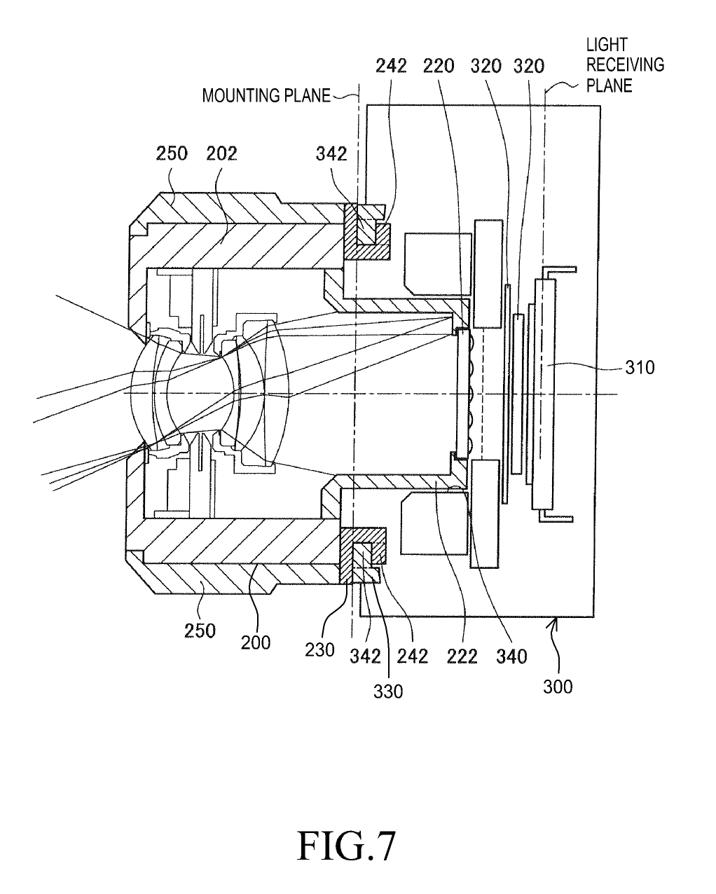

FIG. 7 illustrates a photographing device according to an embodiment of the present invention.

Referring to FIG. 7, the photographing device includes a detachable tube (i.e. a mounting unit support) 250 that is rotatably installed around an outer circumference of the body 202 of the exchangeable lens 200 illustrated in FIG. 1 and the first mounting unit 230 is mounted on the detachable tube 250. This structure enables mounting and removal of the exchangeable lens 200 by rotating the tube 250 without rotating the body 202.

In FIG. 7, the fly's eye lens array support tube 222 is locked non-rotatably to the body 202 of the exchangeable lens 200. Otherwise, the first mounting unit 230, the second mounting unit 330, and the main body 300 have the same structures as in the above-described embodiments of the present invention. Accordingly, a repetitive description of the components will be omitted.

In FIG. 7, when the exchangeable lens 200 is mounted to the main body 300, the first mounting surface of the first mounting unit 230 is brought into contact with the second mounting surface of the second mounting unit 330, the fly's eye lens array support tube 222 is inserted into the opening unit 340, and the first mounting unit 230 is rotated together with the detachable tube 250. Thus, the first and second protrusions 242 and 342 are engaged with each other, thereby locking the exchangeable lens 200 to the main body.

While the basic structure (the first mounting surface, the first protrusions 242, and the first unlocking portions) of the first mounting unit 230 of the exchangeable lens 200 is the same as in the afore-described embodiment of the present invention, the fly's eye lens array support tube 222 is integrated with the body 202 of the exchangeable lens 200 and thus, components such as the rotation restriction plate, the recessed bottom surface, etc., are not provided in the first mounting unit 230.

In FIG. 7, i.e., a system where the exchangeable lens 200 with the fly's eye lens array 220 can be mounted to or removed from the main body 300, the photographing device can suppress interference between a component of the main body 300 and the fly's eye lens array 220 and its support tube 222 and can secure valid space in the main body 300.

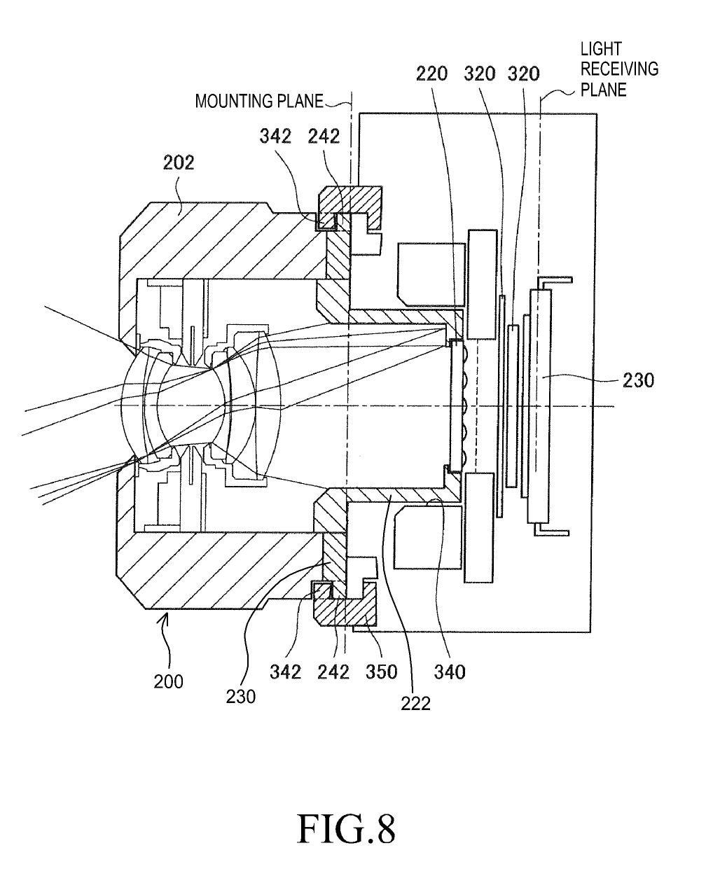

FIG. 8 illustrates a photographing device according to an embodiment of the present invention.

Referring to FIG. 8, a second mounting unit 350 is installed in the main body 300 at a position corresponding to the first mounting unit 230 of the exchangeable lens 200. While the basic structure of the second mounting unit 350, i.e., the basic structure of the second protrusions 342, the second unlocking portions 344, and the second mounting surface are identical to that of the second mounting unit 330 illustrated in FIG. 1, it is different from the second mounting unit 330 in FIG. 1 and FIG. 7 in that it is rotatable with respect to the main body 300.

While the first mounting unit 230 (the first mounting surface, the first protrusions 242, and the first unlocking portions) of the exchangeable lens 200 have the same basic structure in FIGS. 1, in FIG. 8, the fly's eye lens array support tube 222 is integrated with the body 202 of the exchangeable lens 200 and thus, there are no components such as the rotation restriction plate and the recessed bottom surface.

Like the second mounting unit 330 illustrated in FIG. 1, the second mounting unit 350 has the second protrusions 342 and the second unlocking portions. When the first protrusions 242 of the first mounting unit 230 are aligned with the second unlocking portions in the exchangeable lens 200, the support tube 222 is inserted into the opening unit 340. Consequently, the first mounting surface of the exchangeable lens 200 is brought into contact with the second mounting surface of the main body 300.

When the second mounting unit 350 is rotated to a predetermined angle in this state, the second protrusions 342 of the second mounting unit 350 are engaged with the first protrusions 242 of the first mounting unit 230, thereby locking the exchangeable lens 200 to the main body 300.

As illustrated in FIG. 8, because the exchangeable lens 200 can be mounted or removed by rotating the second mounting unit 350 of the main body 300, the fly's eye lens support tube 222 may not be rotated during mounting or removing the exchangeable lens 200. Accordingly, the space of the opening unit 340 into which the fly's eye lens support tube 222 is inserted can be minimized and the main body 300 can be miniaturized.

As described above with reference to FIGS. 4 and 5, when the fly's eye lens array support tube 222 is rotated to mount or remove the exchangeable lens 200, opening unit 340 is formed to be relatively large in the main body 300.

A photographing device according to another embodiment of the present invention is configured to have, in the main body 300, a cylindrical opening unit 341 having a larger diameter than the diagonal length of the fly's eye lens array support tube 222, thereby preventing interference between the fly's eye lens support tube 222 and the opening unit 341 when the fly's eye lens support tube 222 is rotated to mount or remove the exchangeable lens 222. Specifically, the fly's eye lens array tube 222 is locked to the body 202 of the exchangeable lens 200.

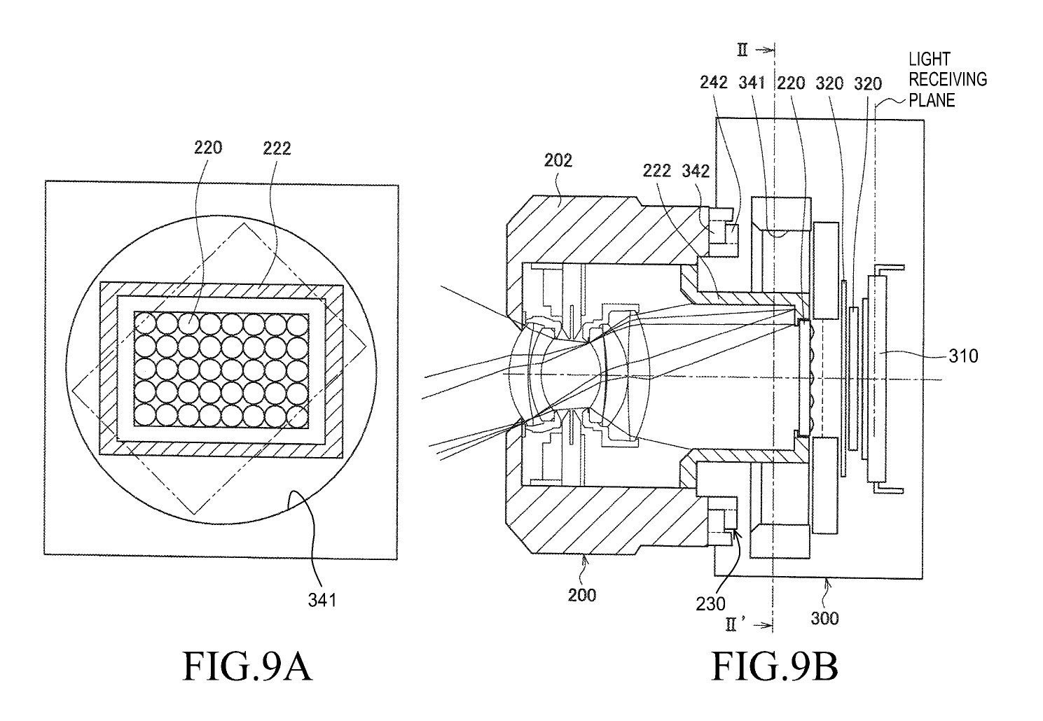

FIGS. 9A and 9B illustrate a photographing device according to an embodiment of the present invention. Specifically, FIG. 9B illustrates a section of the photographing device, taken along an optical axis as illustrated in FIG. 1 and FIG. 9A illustrates the section of the photographing element, taken along a one-dotted dashed line II-II′ illustrated in FIG. 9B.

While the first mounting unit 230 (the first mounting surface, the first protrusion portions 242, and the first unlocking portions) of the exchangeable lens 200 has the same basic structure in FIG. 1, the fly's eye lens array support tube 222 is integrated with the body 202 of the exchangeable lens 200, and thus, there are no components such as the rotation restriction plate and the recessed bottom surface in FIGS. 9A and B.

Referring to FIG. 9B, the opening unit 341 is installed in front of the photographing element 310, for inserting the fly's eye lens support tube 222 therein.

As illustrated in FIG. 9A, the opening unit 341 is formed into a cylinder having a diameter larger than the diagonal length of the fly's eye lens support tube 222 having a rectangular planar shape. Therefore, when the fly's eye lens array support tube 222 is rotated to mount or remove the exchangeable lens 200, interference between the fly's eye lens support tube 222 and the opening unit 341 is prevented.

As described above, because the cylindrical opening unit 341 is installed in the main body 300 and the diameter of the opening unit 341 is large enough to avoid interference with the fly's eye lens support tube 222 when the fly's eye lens support tube 222 is rotated, interference between the fly's eye lens support tube 222 and the opening unit 341 is prevented, when the exchangeable lens 200 is mounted or removed.

As is apparent from the above-described embodiments of the present invention, interference between an exchangeable lens device having an end lens such as a fly's eye lens array and a component of a main body of a photographing device in a system having the exchangeable lens device, is suppressed and system miniaturization is improved.

While the present invention has been particularly shown and described with reference to certain embodiments thereof, it will be understood by those of ordinary skill in the art that various changes in form and details may be made therein without departing from the spirit and scope of the present invention as defined by the following claims and their equivalents.

What is claimed is:

1. A photographing device comprising:
an exchangeable lens unit including an image-forming optical system for capturing an image of an object on a photographing element, an end lens interposed between the image-forming optical system and the photographing element, an end lens support for supporting the end lens, and a first mounting unit; and
a main body including a second mounting unit to which the first mounting unit is mounted, the photographing element disposed inside the second mounting unit, and an opening unit installed at a side of the photographing element in the second mounting unit, for receiving the end lens therein.

2. The photographing device of claim 1, wherein the end lens comprises a fly's eye lens array.

3. The photographing device of claim 1, wherein the second mounting unit comprises a locking pin for locking relative rotation of the second mounting unit with respect to the first mounting unit, and
wherein the first mounting unit comprises a rotation restriction plate coupled to the end lens support, for stopping rotation of the end lens support with respect to the second mounting unit, in engagement with the locking pin.

4. A lens device comprising:
an image-forming optical system for capturing an image of an object on a photographing element installed in a main body of a photographing device;
an end lens interposed between the image-forming optical system and the photographing element;
an end lens support for supporting the end lens; and
a lens mounting unit mounted to the main body.

5. The lens device of claim 4, wherein the end lens comprises a fly's eye lens array.

6. The lens device of claim 4, wherein the main body comprises a locking pin for locking relative rotation of the main body with respect to the lens mounting unit, and
wherein the lens mounting unit comprises a rotation restriction plate coupled to the end lens support, for stopping rotation of the end lens support with respect to the main body, in engagement with the locking pin.

7. A photographing device comprising:
an exchangeable lens unit including an image-forming optical system for capturing an image of an object on a photographing element, an end lens interposed between the image-forming optical system and the photographing element, an end lens support for supporting the end lens, and a first mounting unit ; and
a main body including a second mounting unit to which the first mounting unit is mounted, the photographing element disposed inside the second mounting unit, and an opening unit installed at a side of the photographing element in the second mounting unit, for receiving the end lens therein,
wherein the first mounting unit is mounted to the main body by rotating with respect to the main body.

8. The photographing device of claim 7, wherein the end lens comprises a fly's eye lens array.

9. The photographing device of claim 7, wherein the exchangeable lens unit further comprises a mounting unit support installed around an outer circumference of a lens body of the exchangeable lens unit, for fixing the first mounting unit.

10. A lens device comprising:
an image-forming optical system for capturing an image of an object on a photographing element installed in a main body of a photographing device;
an end lens interposed between the image-forming optical system and the photographing element;
an end lens support for supporting the end lens; and
a lens mounting unit detachably mounted to the main body,
wherein the first mounting unit is mounted to the main body by rotating with respect to the main body.

11. The lens device of claim 10, wherein the end lens comprises a fly's eye lens array.

12. The lens device of claim 10, further comprising a mounting unit support installed around an outer circumference of a lens body of the exchangeable lens unit, for fixing the lens mounting unit.

13. A photographing device comprising:
an exchangeable lens unit including an image-forming optical system for capturing an image of an object on a photographing element, an end lens interposed between the image-forming optical system and the photographing element, a fly's eye lens array support for supporting the end lens, and a first mounting unit; and
a main body including a second mounting unit that mounts to the first mounting unit by rotating the second mounting unit with respect to the main body, the photographing element disposed inside the second mount, and an opening unit installed at a side of the photographing element in the second mounting unit, for receiving the end lens therein.

14. The photographing device of claim 13, wherein the end lens comprises a fly's eye lens array.

15. A photographing device comprising:
an exchangeable lens unit including an image-forming optical system for capturing an image of an object on a photographing element, an end lens interposed between the image-forming optical system and the photographing element, an end lens support for supporting the end lens, and a first mounting unit; and
a main body including a second mounting unit to which the first mounting unit is mounted, the photographing element disposed inside the second mount, and an opening unit installed at a side of the photographing element in the second mounting unit along a trajectory that the end lens draws when the exchangeable lens unit is rotated to be mounted to the main body, for receiving the end lens therein.

16. The photographing device of claim 15, wherein the end lens comprises a fly's eye lens array.
